(19) United States
(12) Patent Application Publication
(10) Pub. No.: US 2020/0398275 A1
(43) Pub. Date: Dec. 24, 2020

(54) Specimen-Processing Device

(71) Applicant: Hitachi High-Tech Corporation, Minato-ku, Tokyo (JP)

(72) Inventors: Yoshihiro NAGAOKA, Tokyo (JP); Motohiro YAMAZAKI, Tokyo (JP)

(21) Appl. No.: 16/957,272

(22) PCT Filed: Jan. 23, 2019
(86) PCT No.: PCT/JP2019/002055

§ 371 Date: Jun. 23, 2020

(30) Foreign Application Priority Data
Jan. 24, 2018 (JP) 2018-009670

(51) Int. Cl. B01L 3/00; G01N 35/08

(52) U.S. Cl. CPC B01L 3/502715; B01L 3/502738; G01N 35/08; G01N 2035/0479; B01L 2200/0684; B01L 2300/0816; B01L 2300/123; B01L 2200/0605

(57) ABSTRACT

Provided is a specimen-processing device configured so that a flow operation can be performed by deforming an elastic membrane. The present invention has an analysis chip that is a processing unit having a first flow path through which a liquid flows on a lower-surface side, a drive unit that controls air, a membrane that is an elastic membrane disposed between the processing unit and the drive unit, and an air pressure control unit that switches the elastic membrane between adhering to the processing-unit side and adhering to the drive-unit side. The processing unit has formed therein a circulation groove that is a second flow path through which air flows, the circulation groove being formed on the opposite side from the side where the drive unit is disposed, and an adhesion film that is a hermetic sealing film, the adhesion film being provided above the second flow path of the processing unit. The processing unit has a plurality of wells that are containers for storing the air and the liquid, each of the wells being connected to the second flow path. The air in the containers flows through the second flow path. This specimen-processing device makes it possible to enable a flow operation in a hermetically sealed processing unit.

### TECHNICAL FIELD

The present invention relates to a specimen-processing device, and more particularly, to a specimen-processing device that performs a liquid flow operation by deforming an elastic membrane.

### BACKGROUND ART

A microfluidic system and method is described in PTL 1. PTL 1 describes a microfluidic system that includes a detachable microfluidic device and control means, the detachable microfluidic device including at least one fluid chamber or flow path between a rigid layer and an elastic layer, the control means including means for deforming the elastic layer by manipulating fluid in the fluid chamber or flow path.

### CITATION LIST

### Patent Literature

PTL 1: WO 2010/073020 A

### SUMMARY OF INVENTION

### Technical Problem

PTL 1 describes the microfluidic system including the control means for deforming the elastic layer by manipulating fluid in the fluid chamber or flow path. The microfluidic device described in PTL 1 enables, by deforming the elastic layer, the flow of fluid into or out of the fluid chamber to which the flow path is connected, but no description has been given of a sealing structure of the microfluidic device. For this reason, when an inflow-upstream side or outflow-downstream side of the fluid is open, the intended flow operation can be performed, but when the device is used in a hermetically sealed state, the flow operation cannot be performed.

An object of the present invention is to solve the above-described problem and to provide a specimen-processing device capable of performing a flow operation by deforming an elastic membrane with the device in a hermetically sealed state.

### Solution to Problem

To achieve the above-described object, the present invention provides a specimen-processing device including a processing unit having a first flow path through which a liquid flows on a lower-surface side, a drive unit that controls air, an elastic membrane disposed between the processing unit and the drive unit, and an air pressure control unit that switches the elastic membrane between adhering to a processing-unit side and adhering to a drive-unit side, in which the processing unit has formed, in the processing unit, a second flow path through which air flows, the second flow path being formed on an opposite side from a side where the drive unit is disposed, a hermetic sealing film provided above the second flow path, and a plurality of containers for storing the air and the liquid, each of the containers being connected to the second flow path, and the air in the plurality of containers flows through the second flow path.

### Advantageous Effects of Invention

According to the present invention, it is possible to provide the specimen-processing device capable of performing a flow operation by deforming the elastic membrane with the device in a hermetically sealed state. Note that problems, configurations, and effects other than those described above will be apparent from the description of the embodiment given below.

### BRIEF DESCRIPTION OF DRAWINGS

FIG. 1 is a top view and side cross-sectional view of an analysis chip according to a first embodiment.

FIG. 2 is a top view and side view of a specimen-processing device according to the first embodiment.

FIG. 3 is diagram showing an air piping system for controlling pressure in a drive unit of the specimen-processing device according to the first embodiment.

FIG. 4 is a flowchart of an operation of the specimen-processing device according to the first embodiment.

FIG. 5 is a flowchart of an analysis operation of the specimen-processing device according to the first embodiment.

FIG. 6 is a flowchart of a specimen introduction operation of the specimen-processing device according to the first embodiment.

FIG. 7A is a diagram showing a first half of the specimen introduction operation of the specimen-processing device according to the first embodiment.

FIG. 7B is a diagram showing a second half of the specimen introduction operation of the specimen-processing device according to the first embodiment.

FIG. 8 is a diagram showing a state, where a specimen is held, of the specimen-processing device according to the first embodiment.

FIG. 9 is a flowchart of a specimen disposal operation of the specimen-processing device according to the first embodiment.

FIG. 10A is a diagram showing a first half of the specimen disposal operation of the specimen-processing device according to the first embodiment.

FIG. 10B is a diagram showing a second half of the specimen disposal operation of the specimen-processing device according to the first embodiment.

FIG. 11 is a flowchart of a specimen cutout operation of the specimen-processing device according to the first embodiment.

FIG. 12A is a diagram showing a first half of the specimen cutout operation of the specimen-processing device according to the first embodiment.

FIG. 12B is a diagram showing a second half of the specimen cutout operation of the specimen-processing device according to the first embodiment.

FIG. 13 is a flowchart of a reagent introduction operation of the specimen-processing device according to the first embodiment.

FIG. 14 is a flowchart of a stirring operation of the specimen-processing device according to the first embodiment.

FIG. 15A is a diagram showing a first half of the stirring operation of the specimen-processing device according to the first embodiment.

FIG. 15B is a diagram showing a second half of the stirring operation of the specimen-processing device according to the first embodiment.

FIG. 16 is a flowchart of a measurement operation of the specimen-processing device according to the first embodiment.

### DESCRIPTION OF EMBODIMENTS

A configuration of the specimen-processing device will be hereinafter described, in a sequential manner, with reference to the drawings. Note that, in a plurality of drawings, in principle, the same component is denoted by the same number. Herein, a sealed device means an analysis chip in which liquid and air to be processed inside are not in contact with the outside.

### First Embodiment

A first embodiment corresponds to an embodiment of a specimen-processing device including a processing unit having a first flow path through which a liquid flows on a lower-surface side, a drive unit that controls air, an elastic membrane disposed between the processing unit and the drive unit, and an air pressure control unit that switches the elastic membrane between adhering to a processing-unit side and adhering to a drive-unit side, in which the processing unit has formed therein a second flow path through which air flows, the second flow path being formed on an opposite side from a side where the drive unit is disposed, a hermetic sealing film provided above the second flow path, and a plurality of containers for storing the air and the liquid, each of the containers being connected to the second flow path, and the air in the plurality of containers flows through the second flow path.

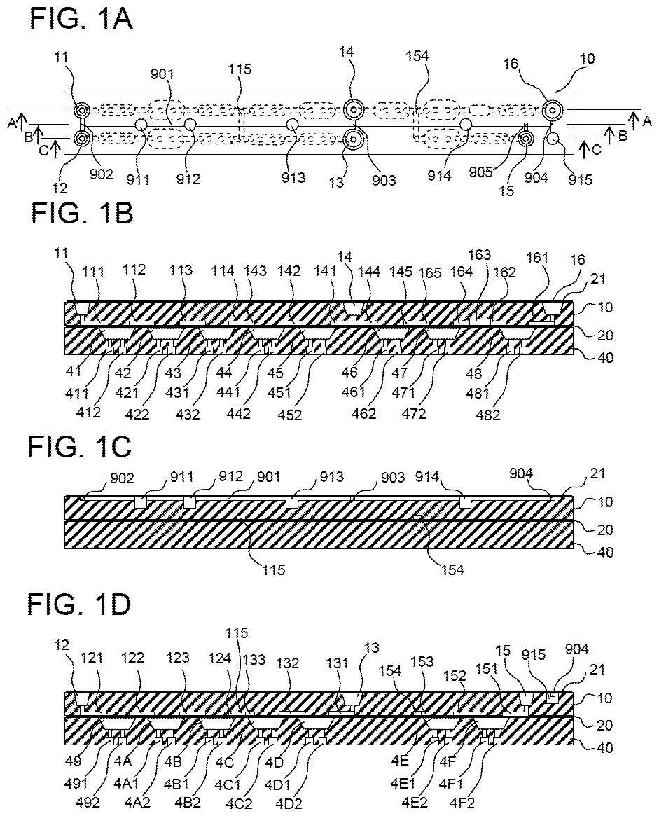

A basic configuration of the specimen-processing device according to the first embodiment will be hereinafter described with reference to FIGS. 1 to 3. In the present embodiment, a description will be given as an example of the specimen-processing device that circulates a liquid specimen such as blood, urine, or swab and a reagent to mix the specimen and the reagent in a constant volume ratio for optical measurement such as identification and quantity determination of a chemical substance.

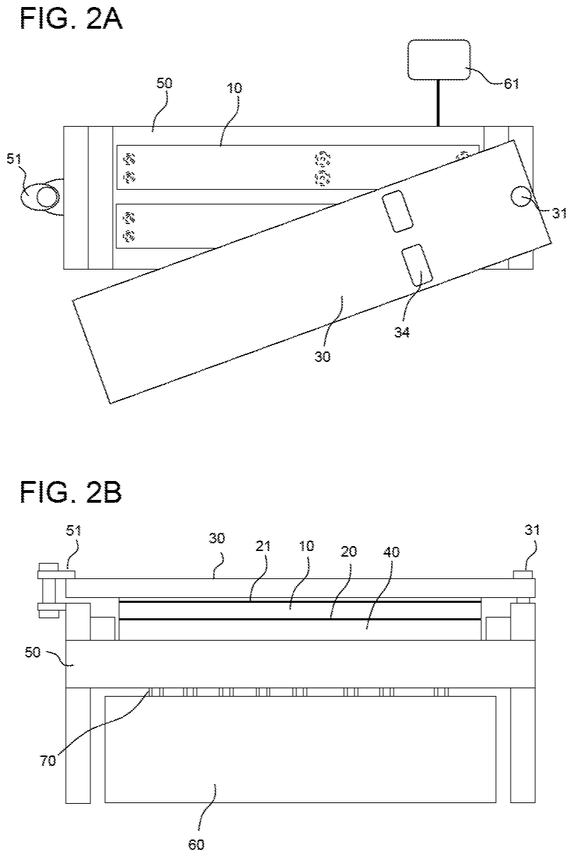

(A), (B) of FIG. 2 are a top view and side view of the specimen-processing device according to the first embodiment. In the specimen-processing device shown in (A), (B) of FIG. 2, an analysis chip 10 that acts as a processing unit and a membrane 20 are pressed against a drive unit 40 by a lid 30, and an upper surface of the analysis chip 10 is hermetically sealed with a hermetic sealing film 21. Herein, such an analysis chip in which an elastic membrane and a hermetic sealing film adhere to each other is referred to as a hermetically sealed device.

The lid 30 is supported rotatable about a rotation support 31, and, in (A) of FIG. 2, the lid 30 is opening, and two analysis chips 10 are arranged side by side. In (B) of FIG. 2, the lid 30 is fully closed and is fastened to a housing 50 by a lock mechanism 51. The lid 30 has an observation window 34 through which an analysis result is observed.

Provided below the housing 50 is an air pressure control unit 60 for controlling air pressure in the drive unit 40, and air piping 70 extending from the drive unit 40 is connected to the air pressure control unit 60. The air pressure control unit 60 is controlled in operation by a signal from an operation unit 61 located outside the device.

(A), (B), (C), (D) of FIG. 1 are a top view, a side cross-sectional view (cross section AA), a side cross-sectional view (cross section BB), and a side cross-sectional view (cross section CC) each showing a state where the analysis chip 10 according to the first embodiment is in close contact with the drive unit with the membrane 20 interposed between the analysis chip 10 and the drive unit. FIG. 1 shows a state where the analysis chip 10 is mounted on the specimen-processing device shown in FIG. 2, and the drive unit 40 is pressed by the lid 30 via the membrane 20.

(A) of FIG. 1 is a top view of the analysis chip 10, in which wells acting as containers on an upper-surface side of the analysis chip, a circulation groove 901 acting as an air circulation path, and the like are represented by solid lines, and a groove 154 on a lower-surface side of the analysis chip, dents acting as dent portions of the drive unit 40, and the like are represented by dashed lines. (B) of FIG. 1 is the cross section AA of (A) of FIG. 1, (C) of FIG. 1 is the cross section BB of (A) of FIG. 1, (D) of FIG. 1 is the cross section CC of (A) of FIG. 1, and the analysis chip 10 and the drive unit 40 are in contact with each other with the membrane 20 interposed between the analysis chip 10 and the drive unit 40.

Provided on the upper-surface side of the analysis chip 10 are a specimen well 11, an air intake well 12, a specimen disposal well 13, a stirring well 14, a reagent well 15, and a mixed liquid disposal well 16 acting as a plurality of containers, air circulation grooves 901, 902, 903, 904, 905 acting as air circulation flow paths, and air reservoirs 911, 912, 913, 914, 915. On the other hand, provided on the upper-surface side are a plurality of grooves 111, 112, 113, 114, 115, 121, 122, 123, 124, 131, 132, 133, 141, 142, 143, 144, 145, 151, 152, 153, 154, 161, 162, 163, 164, 165. As described later, the groove 115 of the above-described grooves acts as a quantity-determining groove.

The membrane 20 is an elastic body made of a polymer compound such as rubber or resin. The membrane 20 is deformed by air pressure to cause a fluid to flow, and adheres to the surface of either the analysis chip 10 or the drive unit 40 to interrupt the flow of the fluid.

The drive unit 40 has a plurality of dents 41, 42, 43, 44, 45, 46, 47, 48, 49, 4A, 4B, 4C, 4D, 4E, 4F acting as a plurality of dent portions provided on an upper-surface side that is in close contact with the membrane 20. Two types of pipes, that is, pressurizing pipes 411, 421, 431, 441, 451, 461, 471, 481, 491, 4A1, 4B1, 4C1, 4D1, 4E1, 4F1, and depressurizing pipes 412, 422, 432, 442, 452, 462, 472, 482, 492, 4A2, 4B2, 4C2, 4D2, 4E2, 4F2 are connected to the air piping 70 shown in FIG. 2.

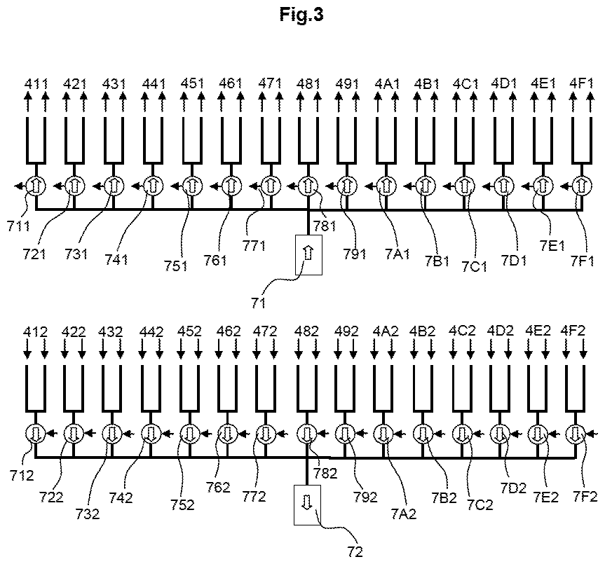

FIG. 3 is a diagram showing an air piping system for controlling pressure in the drive unit 40 of the present embodiment, and the air piping system is installed in the air pressure control unit 60. 15 lines are branched out from a pressurizing pump 71 and are each further branched into two lines via pressurizing solenoid valves 711, 721, 731, 741, 751, 761, 771, 781, 791, 7A1, 7B1, 7C1, 7D1, 7E1, 7F1 and connected to a corresponding one of the pressurizing pipes of the drive unit 40. The reason that the two lines are branched off from each of the pressurizing solenoid valves is because the specimen-processing device of the present embodiment is equipped with two analysis chips as shown in (A) of FIG. 2. Similarly, 15 lines are branched out from a depressurizing pump 72 and each further branched into two lines via depressurizing solenoid valves 712, 722, 732, 742, 752, 762, 772, 782, 792, 7A2, 7B2, 7C2, 7D2, 7E2, 7F2 and connected to a corresponding one of the depressurizing pipes of the drive unit 40.

The pressurizing solenoid valve 711 and the like cause, when energized, the air piping to communicate through from the pump 71 to the drive unit 40 to pressurize the dent 41 and the like of the drive unit 40. On the other hand, when not energized, the air piping adjacent to the pump 71 is closed to allow the outflow of air from the air piping adjacent to the drive unit 40 to the outside, that is, the atmosphere side and interrupt the inflow of air from the outside into the air piping.

The depressurizing solenoid valve 712 and the like cause, when energized, the air piping to communicate through from the pump 72 to the drive unit 40 to depressurize the dent 41 and the like of the drive unit 40. On the other hand, when not energized, the air piping adjacent to the pump 72 is closed to allow the inflow of air from the atmosphere side into the air piping adjacent to the drive unit 40 and interrupt the outflow of air from the air piping to the outside.

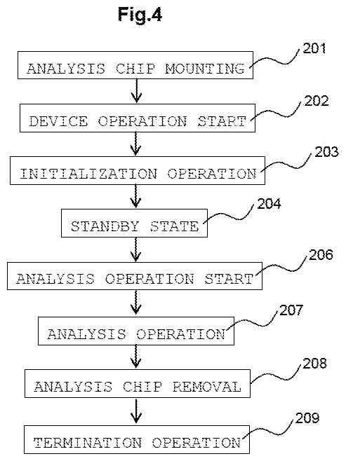

The operation of the specimen-processing device of the present embodiment will be hereinafter described with reference to the operation flow shown in FIG. 4. Before start of the operation, the drive unit 40 is installed in the specimen-processing device, and the air piping 70 is connected. In analysis chip mounting 201 that is a first operation of an operation flow 201 to 209, an operator attaches the membrane 20 to the analysis chip 10, puts the specimen into the specimen well 11, puts the reagent into the reagent well 15, seals the upper surface of the analysis chip 10 with the hermetic sealing film 21 to form a hermetically sealed device, mounts the hermetically sealed device on the drive unit 40 with the membrane 20 facing down, and closes the lid 30. This state is shown in (B) of FIG. 2. Note that, as described above, the analysis chip 10 and the membrane 20 are separate from each other, and the operator attaches the membrane 20 to the analysis chip 10, but the analysis chip 10 and the membrane 20 integrally pre-packaged may be used.

In the next device operation start 202, the operator selects a control procedure in accordance with analysis content using the operation unit 61 shown in (A) of FIG. 2 and starts a device operation. The specimen-processing device starts an initialization operation 203 to perform operations such as an opening and closing operation on the solenoid valves, a pressurizing and depressurizing operation using the pumps, and a pressure check as necessary.

Thereafter, with the pressurizing pump 71 and the depressurizing pump 72 put into operation, the depressurizing solenoid valve 712 and the like are all closed, and at least the pressurizing solenoid valves 711 and 7F1 are open, thereby entering a standby state 204.

Next, the operator issues an instruction for an analysis operation start 206 from the operation unit 61 to cause the specimen-processing device to perform an analysis operation 207. When the analysis is brought to an end, an analysis result is stored in a memory in the specimen-processing device and displayed on a display or the like of the operation unit 61 as necessary.

When the analysis operation 207 is brought to an end, the operator removes, in analysis chip removal 208, the analysis chip 10, the membrane 20, and the like and stores or disposes of the analysis chip 10, the membrane 20, and the like. When there is the next analysis, return to the analysis chip mounting 201, mount a new analysis chip, and then perform the analysis. When there is no other analysis, the operator performs termination operation 209 using the operation unit 61 to bring the device to a stop.

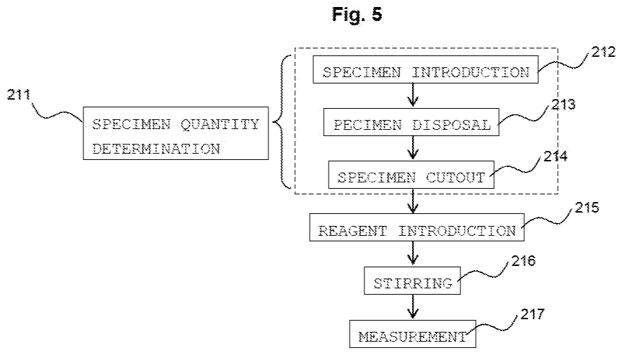

Next, a detailed example of the analysis operation 207 of the specimen-processing device of the present embodiment will be described with reference to FIG. 5.

In specimen introduction 212 shown in FIG. 5, the specimen held in the specimen well 11 is fed toward the specimen disposal well 13 to be introduced into a quantity-determining groove 115. In specimen disposal 213, air is introduced from the air intake well 12 to dispose of an excess specimen into the specimen disposal well 13. In specimen cutout 214, air is introduced from the air intake well 12 to cut out a predetermined amount of specimen held in the quantity-determining groove 115 into the stirring well 14. The series of the above-described operations including the specimen introduction 212, the specimen disposal 213, and the specimen cutout 214 constitute specimen quantity determination 211 for determining quantity of the specimen.

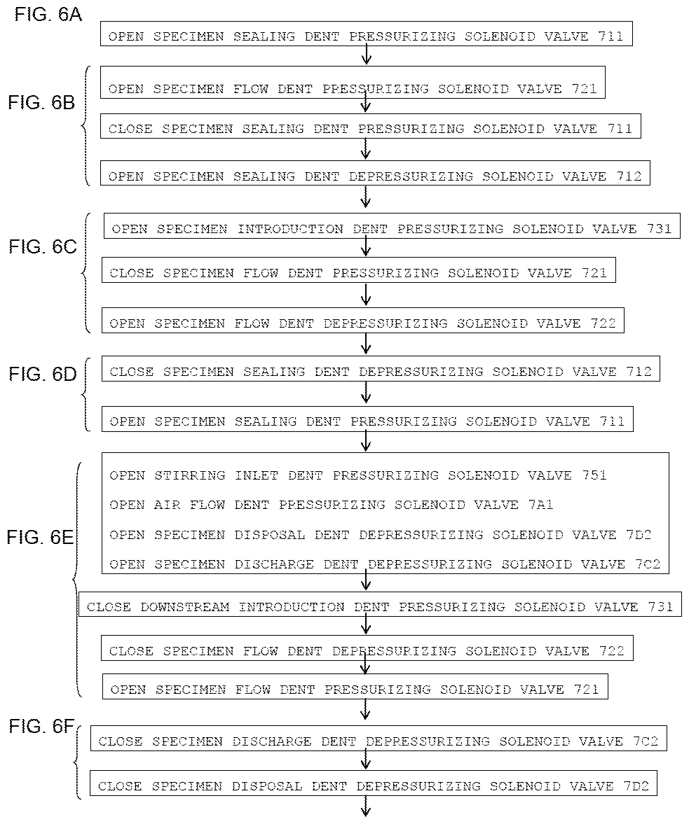

Details of the specimen quantity determination 211 will be hereinafter described. First, the specimen introduction 212 will be described with reference to FIGS. 6, 7A, 7B, and 8.

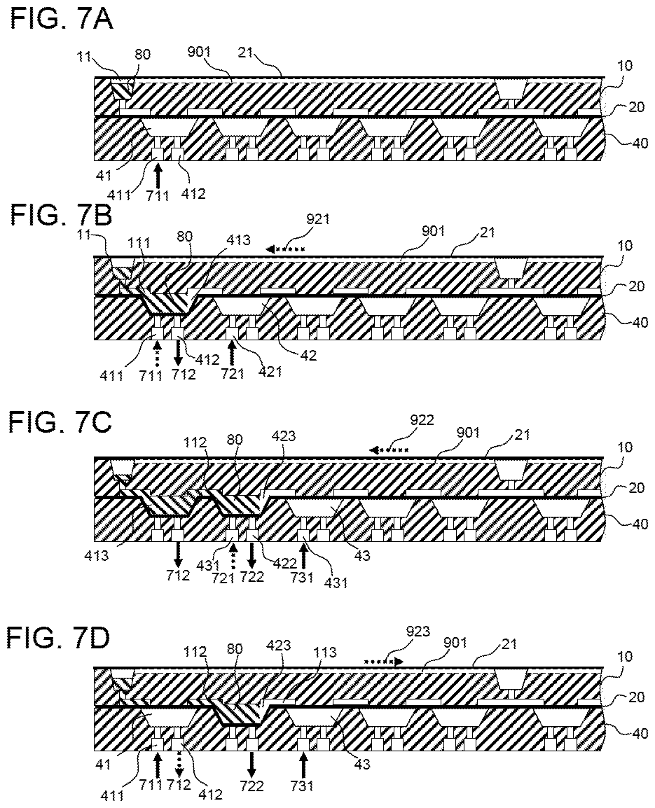

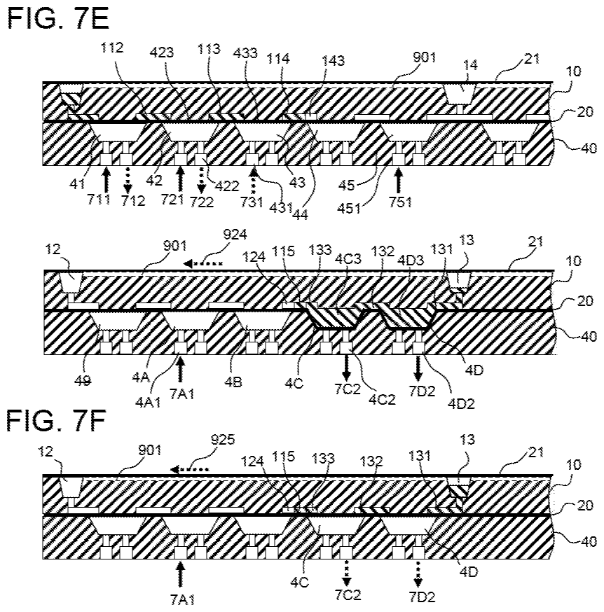

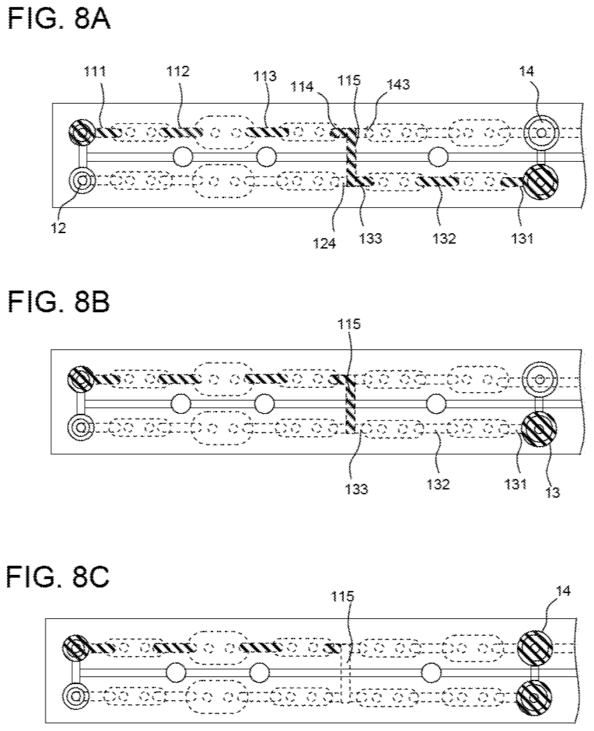

FIG. 6 is a flowchart of the specimen introduction operation performed through opening and closing control of the pressurizing solenoid valves and the depressurizing solenoid valves of the specimen-processing device of the present embodiment, FIGS. 7A and 7B are diagrams showing the specimen introduction operation, and FIG. 8 is a diagram showing a state where the specimen is held. Note that a solid arrow shown in FIGS. 7A and 7B represents that a solenoid valve corresponding to one of the pressurizing pipes and depressurizing pipes is open, a solid arrow pointing upward represents that a dent is pressurized by opening a corresponding pressurizing solenoid valve, and a solid arrow pointing downward represents that a dent is depressurized by opening a corresponding depressurizing solenoid valve. At sections having no solid arrow attached, a solenoid valve is closed, and, particularly for representing that the solenoid valve is closed, a dashed arrow is used in the description of the drawing under reference. That is, a dashed arrow pointing upward represents that a corresponding pressurizing solenoid valve has switched from the open position to the closed position, and a dashed arrow pointing downward represents that a corresponding depressurizing solenoid valve has switched from the open position to the closed position.

Further, FIGS. 7A, 7B, and the like show part of the cross section AA or cross section CC of FIG. 1, and the operation of the present embodiment will be described with the circulation groove 901, shown in the cross section BB, represented by a dashed line. A flow direction of air through the circulation groove is represented by a horizontal dashed arrow.

In (A) of FIG. 6 and (A) of FIG. 7A (cross section AA), a specimen 80 is held in the specimen well 11 at the time of the above-described analysis operation start. That is, in (A) of FIG. 7A, the specimen sealing dent pressurizing solenoid valve 711 is open, so that air flows in from the specimen sealing dent pressurizing pipe 411 to pressurize the specimen sealing dent 41, and the specimen sealing dent depressurizing solenoid valve 712 for the specimen sealing dent depressurizing pipe 412 is closed. Further, although not shown, a reagent is held in the reagent well 15, and the reagent sealing dent pressurizing solenoid valve 7F1 is also open, so that the reagent sealing dent 4F is also pressurized.

Next, as shown in (B) of FIG. 6 and (B) of FIG. 7A (cross section AA), opening the specimen flow dent pressurizing solenoid valve 721 allows the inflow of air from the specimen flow dent pressurizing pipe 421 to pressurize the specimen flow dent 42, closing the specimen sealing dent pressurizing solenoid valve 711 interrupts the inflow of air from the specimen sealing dent pressurizing pipe 411, and opening the specimen sealing dent depressurizing solenoid valve 712 allows the outflow of air from the specimen sealing dent depressurizing pipe 412 to depressurize the specimen sealing dent 41. At this time, since the membrane 20 is drawn to a bottom of the specimen sealing dent 41, a specimen sealing portion gap 413 is formed between the membrane 20 and the analysis chip 10, and the specimen 80 is drawn from the specimen well 11 into the specimen sealing portion gap 413 through the specimen sealing upstream groove 111.

At this time, the specimen 80 flows out from the specimen well 11, thereby causing expansion of the air in the specimen well 11 and drop in pressure in the specimen well 11. However, since the specimen well 11 is connected to other wells 12, 13, 14, and the like through the circulation grooves 902, 901, 903, and the like, air flows into the specimen well 11 as represented by a dashed arrow 921 in (B) of FIG. 7A, so that the pressure in the specimen well 11 hardly drops.

Strictly speaking, the initial air in the wells or circulation grooves provided on the upper-surface side of the analysis chip 10 expands by a volume corresponding to the specimen drawn into the specimen sealing dent 41 and the like, but the volume of the initial air is much larger than the expansion volume, and therefore the drop in pressure is small. Furthermore, when the volume of the initial air is increased by providing the air reservoir 911 and the like, the drop in pressure in the wells becomes negligibly small.

Next, as shown in (C) of FIG. 6 and (C) of FIG. 7A (cross section AA), opening the specimen introduction dent pressurizing solenoid valve 731 with the specimen sealing dent depressurizing solenoid valve 712 open allows the inflow of air from the specimen introduction dent pressurizing pipe 431 to pressurize the specimen introduction dent 43, closing the specimen flow dent pressurizing solenoid valve 721 interrupts the inflow of air from the specimen flow dent pressurizing pipe 421, and opening the specimen flow dent depressurizing solenoid valve 722 allows the outflow of air from the specimen feeding dent depressurizing pipe 422 to depressurize the specimen flow dent 42. At this time, since the membrane 20 is drawn to a bottom of the specimen flow dent 42, a specimen flow portion gap 423 is formed between the membrane 20 and the analysis chip 10, and the specimen 80 is drawn from the specimen sealing portion gap 413 into the specimen flow portion gap 423 through the specimen flow upstream groove 112.

At this time, the specimen 80 further flows out from the specimen well 11, but air flows in through the circulation groove 901 and the like (dashed arrow 922), so that the pressure in the specimen well 11 hardly drops.

Next, as shown in (D) of FIG. 6 and (D) of FIG. 7A (cross section AA), closing the specimen sealing dent depressurizing solenoid valve 712 with the specimen introduction dent pressurizing solenoid valve 731 and the specimen introduction dent depressurizing solenoid valve 722 open interrupts the outflow of air from the specimen sealing dent depressurizing pipe 412, and opening the specimen sealing dent pressurizing solenoid valve 711 allows the inflow of air from the specimen sealing dent pressurizing pipe 411 to pressurize the specimen sealing dent 41. At this time, since the specimen sealing dent 41 and the specimen introduction dent 43 are pressurized, the specimen flow upstream groove 112 and the specimen introduction upstream groove 113 are sealed, and the specimen 80 is held in the specimen flow portion gap 423.

At this time, the specimen 80 in the specimen sealing portion gap 413 returns to the specimen well 11, compressing the air in the specimen well 11 to cause a rise in pressure, but the air flows out through the circulation groove 901 and the like (dashed arrow 923), so that the pressure in the specimen well 11 hardly rises.

Next, as shown in (E) of FIG. 6 and (E) of FIG. 7B (cross-section AA and cross-section CC), with the specimen sealing dent pressurizing solenoid valve 711 open, two new dents, that is, the stirring inlet dent 45 and the air flow dent 4A, are pressurized, and two dents, that is, the specimen discharge dent 4C and the specimen disposal dent 4D, are depressurized. That is, opening the stirring inlet dent pressurizing solenoid valve 751 allows the inflow of air from the stirring inlet dent pressurizing pipe 451 to pressurize the stirring inlet dent 45, opening the air flow dent pressurizing solenoid valve 7A1 allows the inflow of air from the air flow dent pressurizing pipe 4A1 to pressurize the air flow dent 4A, opening the specimen discharge dent depressurizing solenoid valve 7C2 allows the outflow of air from the specimen discharge dent depressurizing pipe 4C2 to depressurize the specimen discharge dent 4C, and opening the specimen disposal dent depressurizing solenoid valve 7D2 allows the outflow of air from the specimen disposal dent depressurizing valve 4D2 to depressurize the specimen disposal dent 4D. In this state, among the four grooves connected to the quantity-determining groove 115, that is, the specimen introduction downstream groove 114, the specimen discharge upstream groove 133, the air branch groove 124, and the specimen branch groove 143, the air branch groove 124 is sealed by the membrane 20 that has been pressed against the lower-surface side of the analysis chip 10 by pressurizing the air flow dent 4A located between the air branch groove 124 and the air intake well 12 located upstream of the air branch groove 124, and the specimen branch groove 143 is also sealed by the membrane 20 that has been pressed against the lower-surface side of the analysis chip 10 by pressurizing the stirring inlet dent 45 located between the specimen branch groove 143 and the stirring well 14 located downstream of the specimen branch groove 143. On the other hand, the specimen discharge upstream groove 133 communicates with the specimen disposal well 13 through a gap formed between the lower surface of the analysis chip 10 and the membrane 20 by depressurizing two dents located between the specimen discharge upstream groove 133 and the specimen disposal well 13 located downstream of the specimen discharge upstream groove 133, that is, both the specimen discharge dent 4C and the specimen disposal dent 4D to draw the membrane 20 to the bottom surfaces of the dents.

In this state, closing the specimen introduction dent pressurizing solenoid valve 731 interrupts the inflow of air from the specimen introduction dent pressurizing pipe 431, and closing the specimen flow dent depressurizing solenoid valve 722 interrupts the outflow of air from the specimen flow dent depressurizing pipe 422. At this time, the membrane 20 on the specimen flow dent 42 is caused to elastically return to the original state to push the specimen 80 out of the specimen flow portion gap 423. However, since the specimen flow upstream groove 112 is sealed by pressurizing the specimen sealing dent 41, the air cannot flow out. Further, although the cutout dent 44 and the air introduction dent 4B are not pressurized, the stirring inlet dent 45 and the air flow dent 4A located forward are pressurized, thereby sealing the specimen branch groove 143 and the air branch groove 124, so that, when the specimen or air is caused to flow into the specimen branch groove 143 or the air branch groove 124, the membrane on both the cutout dent 44 and the air introduction dent 4B must be separated from the lower surface of the analysis chip 10 against elastic force. On the other hand, since both the specimen discharge dent 4C and the specimen disposal dent 4D are depressurized to allow the specimen discharge upstream groove 133 to communicate with the specimen disposal well 13, the specimen 80 and air can flow out. That is, the specimen 80 enters a specimen introduction portion gap 433 between the membrane 20 on the specimen introduction dent 43 and the analysis chip 10 from the specimen flow portion gap 423 through the specimen introduction upstream groove 113, is introduced from the specimen introduction downstream groove 114 to the quantity-determining groove 115, and further flows out from the specimen discharge upstream groove 133 into the specimen disposal well 13 through a specimen discharge portion gap 4C3 between the membrane 20 on the specimen discharge dent 4C and the analysis chip 10, the specimen discharge downstream groove 132, a specimen disposal portion gap 4D3 between the membrane 20 on the specimen disposal dent 4D and the analysis chip 10, and the specimen disposal downstream groove 131.

Finally, opening the specimen flow dent pressurizing pipe 721 pressurizes the specimen flow dent 42 to press the membrane against the analysis chip 10 to fully push out the specimen 80.

At this time, when the specimen 80 flows out into the specimen disposal well 13, the air in the specimen disposal well 13 is compressed to cause a rise in pressure, but the air flows out through the circulation groove 901 and the like (dashed arrow 924), so that the pressure in the specimen disposal well 13 hardly rises.

Next, as shown in (F) of FIG. 6 and (F) of FIG. 7B (cross section CC), closing the specimen discharge dent depressurizing solenoid valve 7C2 and the specimen disposal dent depressurizing solenoid valve 7D2 with the air introduction dent pressurizing solenoid valve 7A1 open interrupts the outflow of air from the specimen discharge dent 4C and the specimen disposal dent 4D. Note that, at this time, although not shown, the specimen flow dent pressurizing solenoid valve 721 and the stirring inlet dent pressurizing solenoid valve 751 remain open. This causes the membrane to elastically return to the lower-surface side of the analysis chip 10 in the specimen discharge portion gap 4C3 and the specimen disposal portion gap 4D3 to push out the specimen 80 into the specimen disposal well 13.

At this time, the specimen 80 further flows out into the specimen disposal well 13, but the air also flows out through the circulation groove 901 and the like (dashed arrow 925). In this state, part of the specimen 80 in the specimen well 11 in the initial state of (A) of FIG. 7A moves into the specimen disposal well 13, thereby only replacing the air in the grooves (111, 112, 113, 114, 115, 133, 132, 131) on the way to the specimen disposal well 13 with the specimen 80; therefore the total volume of the air and the specimen 80 has no change, and the pressure in the analysis chip 10 returns to the initial state.

In this state, the quantity-determining groove 115 is filled with the specimen 80 as shown in (A) of FIG. 8. Note that the specimen sealing upstream groove 111, the specimen flow upstream groove 112, the specimen introduction upstream groove 113, the specimen introduction downstream groove 114, the specimen discharge upstream groove 133, the specimen discharge downstream groove 132, and the specimen disposal downstream groove 131 are also filled with the specimen 80, but the specimen 80 does not enter the air branch groove 124, grooves adjacent to the air intake well 12 located upstream of the air branch groove 124, the specimen branch groove 143, or grooves adjacent to the stirring well 14 located downstream of the specimen branch groove 143.

Up to this point, the specimen introduction 212 shown in FIG. 5, that is, the operation of introducing the specimen 80 held in the specimen well 11 into the quantity-determining groove 115 has been described.

Note that, in the present embodiment, in (E) and (F) of FIG. 7B after the specimen is introduced into the quantity-determining groove 115, the dents closest to the quantity-determining groove 115, that is, the specimen introduction dent 43, the cutout dent 44, the air introduction dent 4B, and the specimen discharge dent 4C are not pressurized. This is because, when the dents closest to the quantity-determining groove 115 are pressurized, the membrane is pushed up in the quantity-determining groove 115, which may reduce the volume and affect the quantity-determination property. For example, in (E) of FIG. 7B, when the air introduction dent 4B rather than the air flow dent 4A is pressurized, the pressurized air pushes up the membrane 20 below the air branch groove 124 and further pushes up the membrane 20 below a branch groove 115. This slightly reduces the volume of the quantity-determining groove 115, and the amount of liquid held decreases accordingly. When the pressurization of the air introduction dent 4B is terminated after the introduction of the specimen into the quantity-determining groove 115, the membrane 20 on the quantity-determining groove 115 elastically returns to the original state, and the volume of the quantity-determining groove 115 returns to the predetermined volume accordingly. At this time, as long as the liquid returns to the quantity-determining groove 115, the quantity-determination property is not lost, but if the air enters, the amount of liquid remains reduced.

Therefore, the analysis chip 10 of the present embodiment is configured, after the specimen is introduced into the quantity-determining groove 115, not to pressurize the four dents closest to the quantity-determining groove 115.

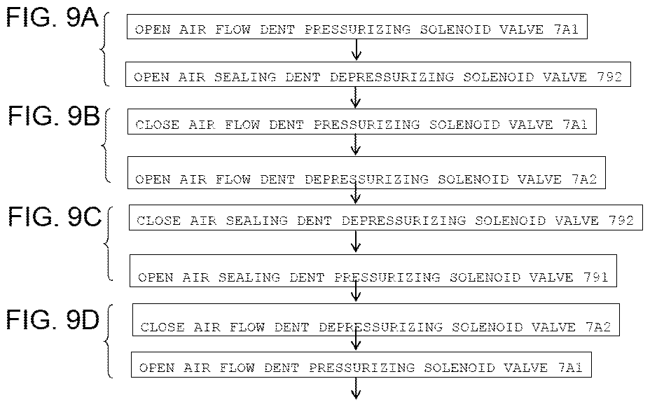

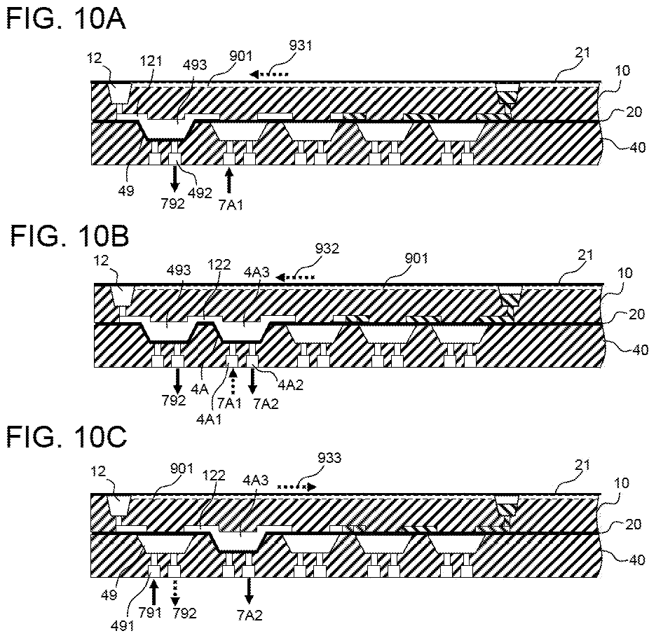

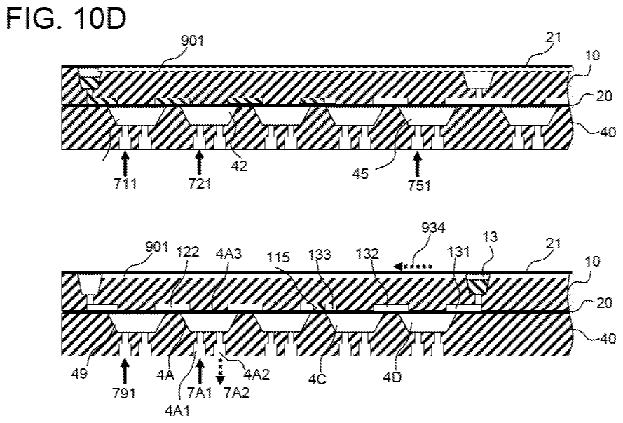

Next, a description will be given of the specimen disposal 213 in the specimen quantity determination 211 shown in FIG. 5 with reference to FIGS. 9, 10A, and 10B.

FIG. 9 is a flowchart of a specimen disposal operation performed through opening and closing control of the pressurizing solenoid valves and the depressurizing solenoid valves of the specimen-processing device of the present embodiment, and FIGS. 10A and 10B are diagrams showing the specimen disposal operation.

(A) of FIG. 9 and (A) of FIG. 10A (cross section CC) correspond to an operation subsequent to (F) of FIG. 6 and (F) of FIG. 7B, in which opening the air sealing dent depressurizing solenoid valve 792 with the air flow dent pressurizing solenoid valve 7A1 open allows the outflow of air from the air sealing dent depressurizing pipe 492 to depressurize the air sealing dent 49. At this time, since the membrane 20 is drawn to a bottom of the air sealing dent 49, an air sealing portion gap 493 is formed between the membrane 20 and the analysis chip 10, and the air is drawn from the air intake well 12 into the air sealing portion gap 493 through the air sealing upstream groove 121.

At this time, since the air flows into the air intake well 12 through the circulation groove 901 and the like (dashed arrow 931), the pressure in the air intake well 12 hardly drops.

Next, as shown in (B) of FIG. 9 and (B) of FIG. 10A (cross section CC), closing the air flow dent pressurizing solenoid valve 7A1 with the air sealing dent depressurizing solenoid valve 792 open interrupts the inflow of air from the air flow dent pressurizing pipe 4A1, and opening the air flow dent depressurizing solenoid valve 7A2 allows the outflow of air from the air flow dent depressurizing pipe 4A2 to depressurize the air flow dent 4A. At this time, since the membrane 20 is drawn to a bottom of the air flow dent 4A, an air flow portion gap 4A3 is formed between the membrane 20 and the analysis chip 10, and the air is drawn from the air sealing portion gap 493 into the air flow portion gap 4A3 through the air flow upstream groove 122.

At this time, since the air flows into the air intake well 12 through the circulation groove 901 and the like (dashed arrow 932), the pressure in the air intake well 12 hardly drops.

Next, as shown in (C) of FIG. 9 and (C) of FIG. 10A (cross-section CC), closing the air sealing dent depressurizing solenoid valve 792 with the air flow dent depressurizing solenoid valve 7A2 open interrupts the outflow of air from the air sealing dent depressurizing pipe 492, and opening the air sealing dent pressurizing solenoid valve 791 allows the inflow of air from the air sealing dent pressurizing pipe 491 to pressurize the air sealing dent 49. At this time, the pressurization of the air sealing dent 49 seals the air flow upstream groove 122 and causes the air to be held in the air flow portion gap 4A3.

At this time, the air in the air sealing portion gap 493 returns to the air intake well 12, but since air flows through the circulation groove 901 and the like (dashed arrow 933), the pressure in the air intake well 12 hardly drops.

Next, as shown in (D) of FIG. 9 and (D) of FIG. 10B (cross section AA and cross section CC), closing the air flow dent depressurizing solenoid valve 7A2 with the air sealing dent pressurizing solenoid valve 791 open interrupts the outflow of air from the air flow dent depressurizing pipe 4A2, and opening the air flow dent pressurizing solenoid valve 7A1 allows the inflow of air from the air flow dent pressurizing pipe 4A1 to pressurize the air flow dent 4A. At this time, the specimen flow dent pressurizing solenoid valve 721 and the stirring inlet dent pressurizing solenoid valve 751 are open, and the specimen flow dent 42 and the stirring inlet dent 45 are pressurized. This causes the membrane 20 on the air flow dent 4A to push the air out of the air flow portion gap 4A3. However, since the air sealing dent 49, the specimen flow dent 42, and the stirring inlet dent 45 are pressurized, the air in the air flow portion gap 4A3 cannot move toward the air sealing upstream groove 122 or the quantity-determining groove 115 and thus moves from the specimen discharge upstream groove 133 to the specimen disposal downstream groove 131 through a gap between the membrane 20 on the specimen discharge dent 4C that is not pressurized and the analysis chip 10, the specimen discharge downstream groove 132, and a gap between the membrane 20 on the specimen disposal dent 4D that is not pressurized and the analysis chip 10 to push out the specimen into the specimen disposal well 13.

At this time, the specimen 80 and the air flow out into the specimen disposal well 13, but the air also flows out through the circulation groove 901 and the like (dashed arrow 934). In this state, only the specimen 80 in the grooves (133, 132, 131, and the like) in the state shown in (F) of FIG. 7B or (A) of FIG. 8 is replaced with the air, and the air corresponds to air that has circulated and flowed in from the air intake well 12 and is identical in volume to the air expelled due to the inflow of the specimen 80 into the specimen disposal well 13; therefore, the volume of air has no change, and the pressure in the analysis chip 10 returns to the initial state.

In this state, as shown in (B) of FIG. 8, the specimen 80 held in the specimen discharge upstream groove 133, the specimen discharge downstream groove 132, and the specimen disposal downstream groove 131 at the time of (A) of FIG. 8 has flowed out into the specimen disposal well 13.

Up to this point, the specimen disposal 213 shown in FIG. 5, that is, the operation of discharging the specimen from the specimen discharge upstream groove 133, the specimen discharge downstream groove 132, and the specimen disposal downstream groove 131 located downstream of the quantity-determining groove 115 into the specimen disposal well 13 has been described.

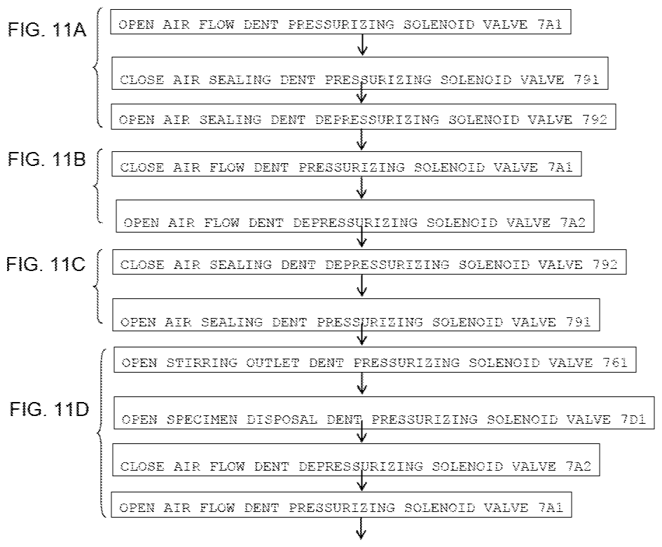

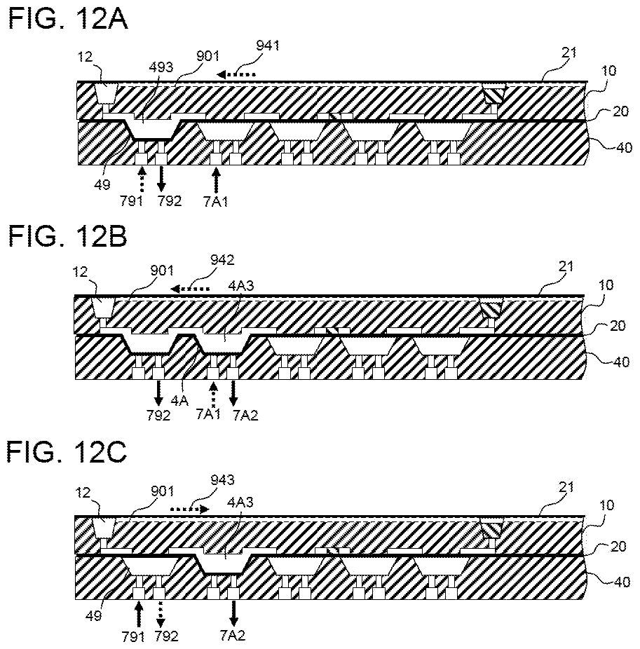

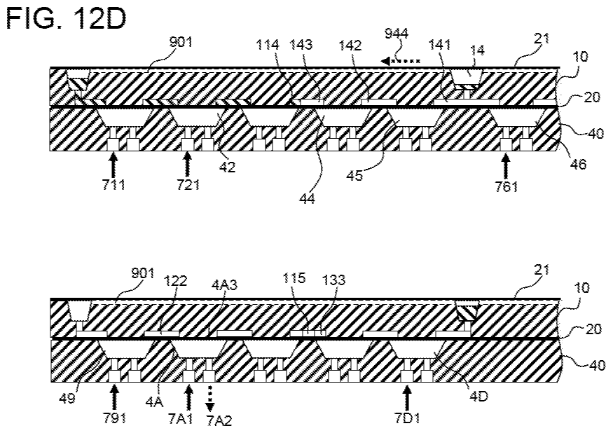

Next, a description will be given of the specimen cutout 214 in the specimen quantity determination 211 shown in FIG. 5 with reference to FIGS. 11, 12A, and 12B.

FIG. 11 is a flowchart of a specimen cutout operation performed through opening and closing control of the pressurizing solenoid valves and the depressurizing solenoid valves of the specimen-processing device of the present embodiment, and FIGS. 12A and 12B are diagrams showing the specimen cutout operation.

(A) of FIG. 11 and (A) of FIG. 12A (cross section CC) correspond to an operation subsequent to (D) of FIG. 9 and (D) of FIG. 10B, and the operation is exactly the same as (A) to (C), except that the air sealing dent pressurizing solenoid valve 791 is closed at the beginning. In other words, in (A) of FIG. 12A, closing the air sealing dent pressurizing solenoid valve 791 and opening the air sealing dent depressurizing solenoid valve 792 with the air flow dent pressurizing solenoid valve 7A1 open depressurize the air sealing dent 49 to draw air into the air sealing portion gap 493. At this time, air flows into the air intake well 12 through the circulation groove 901 and the like (dashed arrow 941). In (B), closing the air flow dent pressurizing solenoid valve 7A1 and opening the air flow dent depressurizing solenoid valve 7A2 depressurize the air flow dent 4A to draw air into the air flow portion gap 4A3. Also at this time, air flows into the air intake well 12 through the circulation groove 901 and the like (dashed arrow 942). In (C), closing the air sealing dent depressurizing solenoid valve 792 and opening the air sealing dent pressurizing solenoid valve 791 pressurize and seal the air sealing dent 49 to hold the air in the air flow portion gap 4A3. At this time, air flows out from the air intake well 12 through the circulation groove 901 and the like (dashed arrow 943).

Next, as shown in (D) of FIG. 11 and (D) of FIG. 12B (cross section AA and cross section CC), opening the stirring outlet dent pressurizing solenoid valve 761 and the specimen disposal dent pressurizing solenoid valve 7D1 pressurize and seal the stirring outlet dent 46 and the specimen disposal dent 4D. At this time, further opening the specimen flow dent pressurizing solenoid valve 721 pressurizes and seals the specimen flow dent 42. In this state, closing the air flow dent depressurizing solenoid valve 7A2 and opening the air flow dent pressurizing solenoid valve 7A1 cause the membrane 20 on the air flow dent 4A to push air out of the air flow portion gap 4A3, but the air flow dent 49 and the specimen disposal dent 4D are pressurized, so that the air in the air flow portion gap 4A3 cannot move toward the air introduction upstream groove 122 or the specimen discharge upstream groove 133 and thus moves to the quantity-determining groove 115 to push the specimen out of the quantity-determining groove 115. However, since the specimen flow dent 42 is sealed, the specimen cannot move toward the specimen introduction downstream groove 114 and thus moves from the specimen branch groove 143 to the stirring inlet downstream groove 141 through a gap between the membrane 20 on the cutout dent 44 that is not pressurized and the analysis chip 10, the cutout downstream groove 142, and a gap between the membrane 20 on the stirring inlet dent 45 that is not pressurized and the analysis chip 10 to be pushed out into the stirring well 14.

At this time, the specimen 80 and the air flow out into the stirring well 14, but the air also flows out through the circulation groove 901 and the like (dashed arrow 944). In this state, only the specimen 80 in a groove 155 in the state shown in (D) of FIG. 10B or (B) of FIG. 8 is replaced with the air, and the air corresponds to air that has circulated and flowed in from the air intake well 12 and is identical in volume to air expelled due to the inflow of the specimen 80 into the stirring well 14; therefore, the volume of air has no change, and the pressure in the analysis chip 10 returns to the initial state.

In this state, as shown in (C) of FIG. 8, the specimen held in the quantity-determining groove 115 at the time of (A) and (B) of FIG. 8 has flowed out into the stirring well 14.

Up to this point, the specimen cutout 214 shown in FIG. 5, that is, the operation of cutting out the specimen located in the quantity-determining groove 115 for the stirring well 14 has been described.

The specimen introduction 212, the specimen disposal 213, and the specimen cutout 214 shown in FIG. 5 constitute the specimen quantity determination 211. In other words, the specimen in the specimen well 11 is once forced to flow toward the specimen disposal well 13 so as to be held in the quantity-determining groove 115, and only the specimen held in the quantity-determining groove 115 is expelled, by air, into the stirring well 14, causing a fixed amount of the specimen, that is, the specimen whose amount is equivalent to the volume of the quantity-determining groove 115, to be held in the stirring well 14.

Note that, in the present embodiment, the specimen disposal 213 and the specimen cutout 214 are performed in this order after the specimen introduction 212; however, the specimen disposal 213 may be omitted, and thus the specimen cutout 214 may be performed subsequent to the specimen introduction 212.

Note that, as is apparent from FIG. 8, the quantity-determining groove 115 formed as a quantity-determining flow path in the analysis chip 10 has branch grooves acting as at least four branch flow paths branched from the quantity-determining groove, and the drive unit 40 installed below the quantity-determining groove 115 has the specimen introduction dent 43, the cutout dent 44, the air introduction dent 4B, and the specimen discharge dent 4C that are each located below an end, remote from the quantity-determining groove 115, of a corresponding one of the four branch grooves.

That is, two of the four branch grooves act as liquid-feeding flow paths, and the remaining two of the four branch grooves act as air-feeding flow paths. Then, one or two sets of flow paths and dents are further provided upstream or downstream of each of the liquid-feeding flow paths, and one or two sets of flow paths and dents are further provided upstream or downstream of each of the air-feeding flow paths, and the dents also communicate with the air pressure control unit 60. The air pressure control unit 60 controls motion of the membrane 20 that is an elastic membrane to fill the quantity-determining groove 115 with liquid using the liquid-feeding flow paths and then cause the liquid in the quantity-determining groove 115 to flow downstream using the air-feeding flow path.

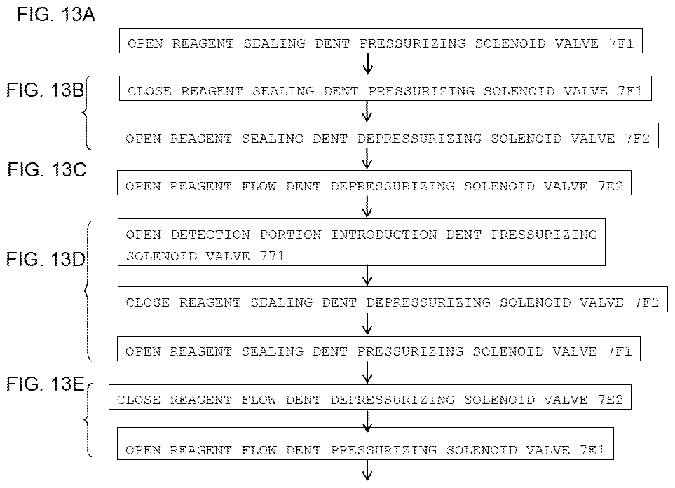

When the specimen quantity determination 211 shown in FIG. 5 is brought to an end, reagent introduction 215 is performed next. In this operation, the reagent in the reagent well 15 moves to the stirring well 14 shown in FIG. 1, and the operation is the same the specimen introduction 212; therefore, the operation flow of the reagent introduction performed through control of the solenoid valves is shown in FIG. 13, and a description will be given of the operation with reference to the reference numerals shown in FIGS. 1 and 3.

(A) of FIG. 13 shows the initial state where the reagent sealing dent pressurizing solenoid valve 7F1 is open, so that the reagent sealing dent 4F is pressurized and sealed, and the reagent in the reagent well 15 does not flow out.

In (B) of FIG. 13, closing the reagent sealing dent pressurizing solenoid valve 7F1 and opening the reagent sealing dent depressurizing solenoid valve 7F2 depressurize the reagent sealing dent 4F to draw the reagent from the reagent well 15 into a gap formed between the membrane 20 and the lower surface of the analysis chip 10. At this time, air flows into the reagent well 15 through the circulation groove 901 and the like.

In (C) of FIG. 13, opening the reagent flow dent depressurizing solenoid valve 7E2 depressurizes the reagent flow dent 4E to further draw the reagent into the gap formed between the membrane 20 and the lower surface of the analysis chip 10. Also at this time, air flows into the reagent well 15 through the circulation groove 901 and the like.

In (D) of FIG. 13, opening the detection portion introduction dent pressurizing solenoid valve 771 pressurizes and seals the detection portion introduction dent 47, and closing the reagent sealing dent depressurizing solenoid valve 7F2 and opening the reagent sealing dent pressurizing solenoid valve 7F1 pressurize and seal the air sealing dent 4F. Also at this time, air flows out from the reagent well 15 through the circulation groove 901 and the like.

In (E) of FIG. 13, closing the reagent flow dent depressurizing solenoid valve 7E2 and opening the reagent flow dent pressurizing solenoid valve 7E1 pressurize the reagent flow dent 4E to push the reagent out. At this time, since the reagent sealing dent 4F is sealed, the reagent cannot move toward the reagent flow downstream groove 152 and thus moves from the reagent flow upstream groove 153 to the joining groove 154. Furthermore, since the detection portion introduction dent 47 is sealed, the reagent cannot move toward the detection portion introduction upstream groove 165 and thus moves from the stirring outlet downstream groove 145 to the stirring outlet upstream groove 144 through a gap between the membrane 20 on the stirring outlet dent 46 that is not pressurized and the analysis chip 10 to be pushed out into the stirring well 14. At this time, air flows out from the stirring well 14 into the circulation groove 901 and the like, and the pressure returns to the initial state.

Up to this point, the reagent introduction 215 shown in FIG. 5, that is, the operation of transferring the reagent from the reagent well 15 to the stirring well 14 has been described.

In this manner, the specimen is held in the stirring well 14 by the specimen quantity determination 211, and the reagent is held in the stirring well 14 by the reagent introduction 215. Note that the specimen and the reagent only need to be held in the stirring well 14; therefore, the specimen quantity determination 211 may be performed after the reagent introduction 215.

The specimen is determined in quantity by the volume of the quantity-determining groove, but the reagent is determined in quantity by the volume of the reagent flow dent 4E, more precisely, a volume resulting from subtracting a volume equivalent to the thickness of the membrane 20 from the volume of the reagent flow dent 4E. Alternatively, the reagent is determined in quantity by an injection amount into the reagent well 15. That is, when the quantity determination is performed on the basis of the reagent flow dent 4E, the reagent whose amount is larger than a liquid amount to be determined is injected into the reagent well 15, and the reagent introduction 215 is performed, thereby allowing a predetermined amount of liquid to move to the stirring well 14. Alternatively, when the quantity determination is performed on the basis of the injection amount into the reagent well 15, the reagent whose amount is smaller than the volume of the reagent flow dent 4E only needs to be injected into the reagent well 15. When it is desired to determine a large liquid amount, the reagent introduction 215 may be performed a plurality of times.

Note that the liquid is forced to flow by deforming the membrane 20; therefore, when the amount of deformation is small, it is difficult to secure the quantity-determination property. Therefore, when a trace amount of liquid is determined in quantity, it is necessary to make the amount of deformation of the membrane 20 small by making the reagent flow dent small in the reagent introduction 215, whereas the method based on the quantity-determining groove 115 used in the specimen quantity determination 211 eliminates the need of making the specimen flow dent 42 small and is suitable for quantity determination of a trace amount of liquid. Therefore, whether to use the specimen quantity determination 211 or the reagent introduction 215 depends on the amount of liquid and a specification of quantity determination reproducibility.

In the present embodiment, the quantity-determining groove 115 is used for quantity determination of the specimen, and the volume of the reagent flow dent is used for quantity determination of the reagent; however, a method in which a quantity-determining groove is also used for quantity determination of the reagent, that is, quantity-determining grooves are used for both the quantity determination of the specimen and the quantity determination of the reagent, or a method in which one quantity-determining groove is used in order is conceivable. Further, the number of quantity-determining grooves is not limited to one or two, and three or more quantity-determining grooves may be provided.

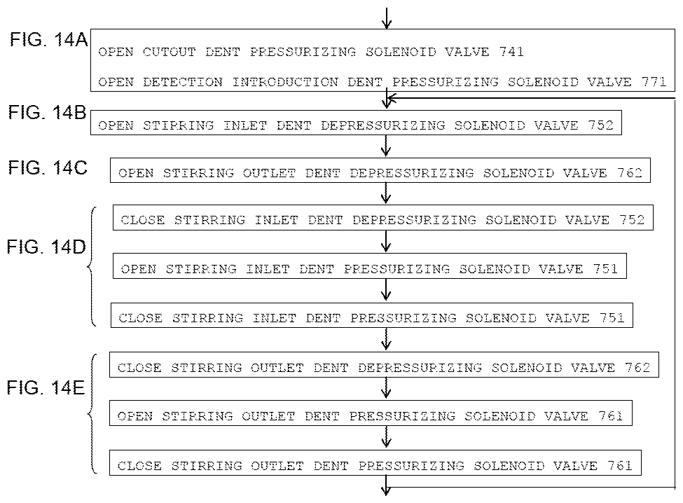

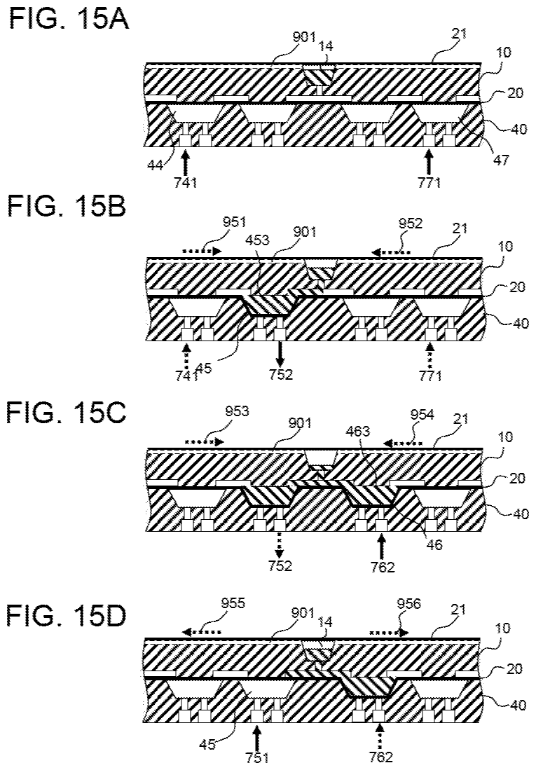

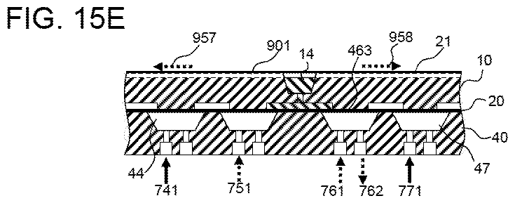

Next, a description will be given of stirring 216 shown in FIG. 5 with reference to FIGS. 14, 15A, and 15B.

FIG. 14 is a flowchart of a stirring operation through opening and closing control of the pressurizing solenoid valves and the depressurizing solenoid valve of the specimen-processing device of the present embodiment, and FIGS. 15A and 15B are diagrams showing the stirring operation.

(A) of FIG. 14 and (A) of 15A (cross section AA) show a state where a plurality of liquid specimens and reagents joined in the stirring well 14 are held, in which, under the control of the air pressure control unit 60, the drive unit 40 opens the cutout dent pressurizing solenoid valve 741 and the detection portion introduction dent pressurizing solenoid valve 771 to pressurize and seal the cutout dent 44 and the detection portion introduction dent 47.

In (B) of FIG. 14 and (B) of FIG. 15A (cross section AA), the drive unit 40 opens the stirring inlet dent depressurizing solenoid valve 752 to depressurize the stirring inlet dent 45 and draw the liquid into a stirring inlet portion gap 453 that is a gap formed between the membrane 20 and the analysis chip 10. At this time, air flows into the stirring well 14 through the circulation groove 901 and the like (dashed arrows 951, 952).

In (C) of FIG. 14 and (C) of FIG. 15A (cross section AA), the drive unit 40 opens the stirring outlet dent depressurizing solenoid valve 762 after (B) of FIG. 14 to depressurize the stirring outlet dent 46 and draw the liquid into a stirring outlet portion gap 463 that is a gap formed between the membrane 20 and the analysis chip 10. At this time, air flows into the stirring well 14 through the circulation groove 901 and the like (dashed arrows 953, 954).

In (D) of FIG. 14 and (D) of FIG. 15A (cross section AA), the drive unit 40 closes, after the (C) of FIG. 14, the stirring inlet dent depressurizing solenoid valve 752 and opens the stirring inlet dent pressurizing solenoid valve 751 to pressurize the stirring inlet dent 45 to return the liquid in the stirring inlet portion gap 453 to the stirring well 14, and then closes the stirring inlet dent pressurizing solenoid valve 751. At this time, air flows out from the stirring well 14 through the circulation groove 901 and the like (dashed arrows 955, 956).

In (E) of FIG. 14 and (E) of FIG. 15B (cross section AA), the drive unit 40 closes, after the (D) of FIG. 14, the stirring outlet dent depressurizing solenoid valve 762 and opens the stirring outlet dent pressurizing solenoid valve 761 to return the liquid in the stirring outlet portion gap 463 to the stirring well 14, and then closes the stirring outlet dent pressurizing solenoid valve 761. At this time, air flows out from the stirring well 14 through the circulation groove 901 and the like (dashed arrows 957, 958).

The drive unit 40 repeatedly performs the above-described operations (B) to (E) to stir the liquid in the stirring well 14 every time the liquid moves to the stirring inlet dent 45 and the stirring outlet dent 46 and then returns to the stirring well 14 again. Up to this point, the stirring 216 shown in FIG. 5 has been described.

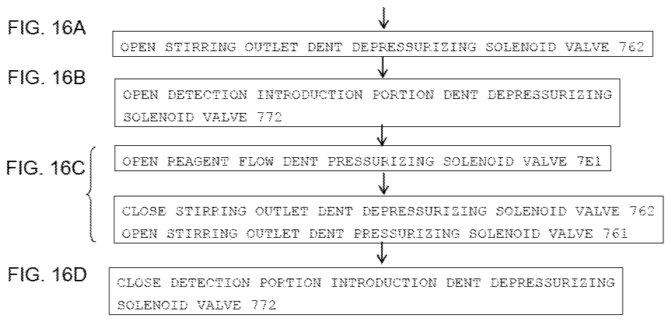

Next, a description will be given of measurement 217 shown in FIG. 5 with reference to FIGS. 16, 1, and 3. FIG. 16 is a flowchart of a measurement operation performed through opening and closing control of the pressurizing solenoid valves and the depressurizing solenoid valves of the specimen-processing device of the present embodiment.

In (A) of FIG. 16, opening the stirring outlet dent depressurizing solenoid valve 762 depressurizes the stirring outlet dent 46 to draw, from the stirring outlet upstream groove 144, the mixed liquid held in the stirring well 14 after the stirring. At this time, air flows into the stirring well 14 through the circulation groove 901 and the like.

Next, in (B) of FIG. 16, opening the detection introduction portion dent depressurizing solenoid valve 772 depressurizes the detection portion introduction dent 47 to draw the mixed liquid from the stirring outlet downstream groove 145 and a detection portion upstream groove. Also at this time, air flows into the stirring well 14 through the circulation groove 901 and the like.

Next, in (C) of FIG. 16, opening the reagent flow dent pressurizing solenoid valve 7E1 pressurizes and seals the reagent flow dent 4E, and closing the stirring outlet dent depressurizing solenoid valve 762 and opening the stirring outlet dent pressurizing solenoid valve 761 pressurize the stirring outlet dent 46. At this time, air flows out from the stirring well 14 through the circulation groove 901 and the like.

Next, in (D) of FIG. 16, the detection portion introduction dent depressurizing solenoid valve 772 is closed. At this time, the membrane 20 on the detection portion introduction dent 47 is caused to elastically return to the lower-surface side of the analysis chip 10 to push the mixed liquid out. Since the stirring outlet dent 46 and the reagent flow dent 4E are sealed, the mixed liquid moves to a gap between the membrane 20 on the mixed liquid disposal dent 48 that is not pressurized and the analysis chip 10 and the mixed liquid disposal downstream groove 161 while filling the detection portion downstream groove 164, the detection groove 163, and the mixed liquid disposal upstream groove 162, and excess mixed liquid is pushed out into the mixed liquid disposal well 16. At this time, air flows out from the mixed liquid disposal well 16 through the circulation groove 901 and the like.

In this state, observation light is applied to the detection groove 163 from the observation window 34 shown in FIG. 2 to acquire data.

Up to this point, the measurement 217 shown in FIG. 5 has been described, and the analysis operation 207 shown in FIG. 4 is brought to an end.

Note that the detection groove 163 is capable of hermetically holding the liquid, and in the first embodiment described in detail above, the analysis operation of applying the observation light to the detection groove 164 from the observation window 34 to acquire data has been described, but processing in the processing grooves of the present embodiment is not limited to analysis and detection. For example, processing, other than optical measurement, such as processing in which two liquids are first stirred in the stirring 216 shown in FIG. 5, held in the detection groove 163 for reaction, and then recovered from the mixed liquid disposal well 16 or processing in which the liquids are held in the detection groove 163 for temperature adjustment may be performed.

The description of the above embodiment have been given in detail for better understanding of the present invention, and the present invention is not necessarily limited to an embodiment having all the configurations described above. Further, it is possible to add a different configuration to part of the configuration of the embodiment, delete the part of the configuration, or replace the part of the configuration with a different configuration. For example, while the description has been given of the hermetically sealed device configured to process a liquid and air inside, the hermetically sealed device may be configured to process gas other than a liquid or air.

According to the present invention, deforming the membrane 20 using air pressure circulates air through the circulation groove for liquid feeding, quantity determination, stirring, or the like, which makes the degree of change in air pressure in the wells small and thereby enables a stable flow operation.

### REFERENCE SIGNS LIST

10 analysis chip
11 specimen well
12 air intake well
13 specimen disposal well
14 stirring well
15 reagent well
16 mixed liquid disposal well
111, 112, 113, 114, 121, 122, 123, 131, 132, 141, 142, 144, 145,
151, 152, 153, 154, 161, 162, 164, 165 groove
115 quantity-determining groove
124, 143 branch groove
163 detection groove
20 membrane
21 hermetic sealing film
30 lid
31 rotation support
34 observation window
40 drive unit
41, 42, 43, 44, 45, 46, 47, 48, 49, 4A, 4B, 4C, 4D, 4E, 4F dent
411, 421, 431, 441, 451, 461, 471, 481, 491, 4A1, 4B1, 4C1, 4D1,
4E1, 4F1 pressurizing pipe
412, 422, 432, 442, 452, 462, 472, 482, 492, 4A2, 4B2, 4C2, 4D2,
4E2, 4F2 depressurizing pipe
50 housing
51 lock mechanism
60 air pressure control unit
61 operation unit
70 air piping
71 pressurizing pump
711, 721, 731, 741, 751, 761, 771, 781, 791, 7A1, 7B1, 7C1, 7D1,
7E1, 7F1 pressurizing solenoid valve
72 depressurizing pump
712, 722, 732, 742, 752, 762, 772, 782, 792, 7A2, 7B2, 7C2, 7D2,
7E2, 7F2 depressurizing solenoid valve
901, 902, 903, 904, 905 circulation groove
911, 912, 913, 914, 915 air reservoir

1. A specimen-processing device comprising:
a processing unit having a first flow path through which a liquid flows on a lower-surface side;
a drive unit that controls air;
an elastic membrane disposed between the processing unit and the drive unit; and
an air pressure control unit that switches the elastic membrane between adhering to a processing-unit side and adhering to a drive-unit side,
wherein the processing unit has formed, in the processing unit, a second flow path through which air flows, the second flow path being formed on an opposite side from a side where the drive unit is disposed, a hermetic sealing film provided above the second flow path, and a plurality of containers for storing the air and the liquid, each of the containers being connected to the second flow path, and
the air in the plurality of containers flows through the second flow path.

2. The specimen-processing device according to claim 1, wherein the drive unit has a dent portion on a side where the processing unit is disposed.

3. The specimen-processing device according to claim 2, wherein the air pressure control unit controls air pressure in the first flow path and the second flow path in conjunction with pressurization and depressurization control of the air in the dent portion.

4. The specimen-processing device according to claim 2, wherein at least three of the dent portions of the drive unit are formed between the plurality of containers.

5. The specimen-processing device according to claim 1, wherein the plurality of containers include a specimen well, an air intake well, a specimen disposal well, a stirring well, a reagent well, and a mixed liquid discharge well.

6. The specimen-processing device according to claim 1, wherein the processing unit includes a quantity-determining flow path for determining quantity of the liquid, and at least four branch flow paths branched from the quantity-determining flow path,
the drive unit has a dent portion below an end, remote from the quantity-determining flow path, of each of the four branch flow paths, and
the four dent portions communicate with the air pressure control unit.

7. The specimen-processing device according to claim 6, wherein two of the four branch flow paths act as liquid-feeding flow paths through which the liquid is fed, and remaining two of the four branch flow paths act as air-feeding flow paths through which the air is fed.

8. The specimen-processing device according to claim 7, further comprising a set of a flow path and dent portion provided upstream or downstream of each of the liquid-feeding flow paths, and a set of a flow path and dent portion provided upstream or downstream of each of the air-feeding flow paths, the dent portions communicating with the air pressure control unit.

9. The specimen-processing device according to claim 7, further comprising two sets of flow paths and dent portions provided upstream or downstream of each of the liquid-feeding flow paths, and two sets of flow paths and dent portions provided upstream or downstream of each of the air-feeding flow paths, the dent portions communicating with the air pressure control unit.

10. The specimen-processing device according to claim 8, wherein the air pressure control unit controls motion of the elastic membrane to fill the quantity-determining flow path with the liquid using the liquid-feeding flow paths, and causes the liquid in the quantity-determining flow path to flow downstream using the air-feeding flow paths.

11. The specimen-processing device according to claim 1, wherein one of the plurality of containers acts as a stirring well for stirring a plurality of liquids.

12. The specimen-processing device according to claim 11, further comprising first and second liquid flow paths branched from the stirring well,
wherein the drive unit has a dent portion below an end, remote from the stirring well, of each of the first and second liquid flow paths, and
the two dent portions communicate with the air pressure control unit.

13. The specimen-processing device according to claim 12, wherein the drive unit depressurizes the dent portion of a stirring inlet to draw the plurality of liquids joined in the stirring well using the first liquid flow path, depressurizes the dent portion of a stirring outlet, and starts to draw the plurality of liquids from the stirring well to the second liquid flow path.

14. The specimen-processing device according to claim 13, wherein the drive unit pressurizes, after drawing the plurality of liquids from the stirring well into the second liquid flow path, the dent portion of the stirring inlet to return the plurality of liquids from the first liquid flow path to the stirring well, and returns the plurality of liquids from the second liquid flow path to the stirring well.

15. The specimen-processing device according to claim 14, wherein the drive unit repeatedly draws the liquids into the first liquid flow path and the second liquid flow path and returns the liquids from the first flow path and the second liquid flow path.
